(19) United States
(12) Patent Application Publication
(10) Pub. No.: US 2010/0036735 A1
(43) Pub. Date: Feb. 11, 2010

(54) TRIGGERING IMMERSIVE ADVERTISEMENTS IN A VIRTUAL UNIVERSE

(75) Inventors: Rick A. HAMILTON, II, Charlottesville, VA (US); Brian M. O'Connell, Cary, NC (US); Clifford A. Pickover, Yorktown Heights, NY (US); Anne R. Sand, Peyton, CO (US); Keith R. Walker, Austin, TX (US)

Correspondence Address: GREENBLUM & BERNSTEIN, P.L.C., 1950 ROLAND CLARKE PLACE, RESTON, VA, 20191, US

(73) Assignee: International Business Machines Corporation, Armonk, NY (US)

(21) Appl. No.: 12/189,225

(22) Filed: Aug. 11, 2008

(51) Int. Cl. G06Q 30/00

(52) U.S. Cl. 705/14.55

(57) ABSTRACT

The invention generally relates to systems and methods for advertising, and, more particularly, to systems and methods for triggering immersive advertising in a virtual universe. In an embodiment, a method includes: obtaining tolerance data about a user who triggers a virtual universe advertisement (VU-ad) in a virtual universe (VU); and presenting a variation of the VU-ad to the user based upon the tolerance data.

### FIELD OF THE INVENTION

The invention generally relates to systems and methods for advertising, and, more particularly, to systems and methods for triggering immersive advertising in a virtual universe.

### BACKGROUND

The concept of a virtual universe (also called a virtual world or a metaverse) is rapidly becoming a popular part of today's culture. In general, a virtual universe (VU) is a digital world (e.g., a three-dimensional computer-generated landscape) in which a user controls an avatar (e.g., a graphical representation of the user in the VU) to interact with objects and other avatars within the VU. Examples of popular VUs include SECOND LIFE® (a registered trademark of Linden Research, Inc. in the United States, other countries, or both) and ACTIVEWORLDS® (a registered trademark of Activeworlds, Inc. in the United States, other countries, or both).

Generally, a host computing system stores data regarding the landscape, objects, and users of the VU. A client software program runs on each user computer. The client program communicates (e.g., through a network connection) with the host system, and provides a visual (and, sometimes, audible) representation of the VU on the user computer. As the user moves his or her avatar throughout the VU, the visual representation displayed on the user computer changes according to the avatar location in the VU. In this manner, a user may cause his or her avatar to approach other avatars and interact with the other avatars. For example, one avatar may approach and communicate with another avatar via VOIP (voice over IP) and/or text-based communication through the network.

Moreover, in some VUs, users may possess virtual money that is purchased with real money. For example, a user may allow a VU host to debit his or her credit card in exchange for virtual money. The user can then exchange this virtual money with other users of the virtual world for a wide range of items and/or services, such as, for example, objects (e.g., clothing for an avatar), access to private areas of the VU, etc.

Additionally, in some VUs, users may even own virtual real estate. For example, a user may pay the VU host, or another third party, real money for an area of virtual real estate in the VU. The user may then create objects on that real estate, such as a night club where music plays and other avatars are invited to congregate to socialize (e.g., chat, dance, etc.).

With the possibility of owning virtual real estate and creating objects on that real estate that other users can see and hear, it is not surprising that entities have begun advertising inside VUs. However, although advertising is ubiquitous in real life today, advertising is only beginning to be realized and utilized in VUs. Current methods of advertising in VUs are generally passive. For example, billboards having logos, brand names, animated commercials, etc., are often created and displayed in various spaces of the VU. Like conventional television ads, such billboards provide a brief summary of a product or service. Similarly, some companies have created virtual showrooms in which likenesses of real-world products are displayed. However, such passive advertising is easily ignored and/or does not generate sufficient interest in many users, and thus often provides little value to the advertiser.

### SUMMARY

In a first aspect of the invention, there is a computer implemented method. The method comprises obtaining tolerance data about a user who triggers a virtual universe advertisement (VU-ad) in a virtual universe (VU). The method also includes presenting a variation of the VU-ad to the user based upon the tolerance data.

In another aspect of the invention, there is a computer implemented method for providing customized advertising in a virtual universe. The method comprises providing a program that defines a virtual universe advertisement (VU-ad), and presenting a first variation of the VU-ad to a first user based upon first tolerance data associated with the first user. The method also includes presenting a second variation of the VU-ad to a second user based upon second tolerance data associated with the second user. The second variation is different from the first variation.

In another aspect of the invention, there is a method for advertising in a virtual universe. The method comprises providing a computer infrastructure structured and arranged to: access a profile of a user upon the user triggering a virtual universe advertisement (VU-ad) in a virtual universe (VU); determine from the profile a tolerance level for advertising; and present a variation of the VU-ad to the user based upon the tolerance level.

In another aspect of the invention, a computer program product comprises a computer usable medium having a computer readable program embodied in the medium, wherein the computer readable program when executed on a computing device causes the computing device to present a variation of a virtual universe advertisement (VU-ad) to a user upon triggering of the VU-ad by the user, wherein the variation is customized based upon a tolerance level of the user.

In another aspect of the invention, there is a system comprising computing hardware and software that is structured and arranged to: obtain tolerance data about a user who triggers a virtual universe advertisement (VU-ad) in a virtual universe (VU); and present a variation of the VU-ad to the user based upon the tolerance data. The tolerance data is stored in a profile associated with the user, and the tolerance data is obtained from the user after the VU-ad is triggered.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows an illustrative environment for implementing the steps in accordance with the invention;

FIG. 2 shows an exemplary system according to aspects of the invention; and

FIGS. 3 and 4 show flow diagrams depicting implementations of a method according to aspects of the invention.

### DETAILED DESCRIPTION

The invention generally relates to systems and methods for advertising, and, more particularly, to systems and methods for triggering immersive advertising in a virtual universe. Exemplary embodiments of the invention allow advertising experience in a VU to be customized to a potential customer (e.g., a user controlling an avatar in a VU) when the advertisement is triggered. The customization may be based on various factors, such as, for example: how much disruption a customer is willing to tolerate, customer preference of advertisement type, incentives a customer is willing to accept for viewing an advertisement, etc. In this manner, the user is provided with a memorable interactive experience, which may lead to an increased likelihood of success for the advertisement.

Online virtual universes or environments present a tremendous new outlet for both structured and unstructured virtual collaboration, gaming and exploration, as well as real-life simulations in virtual spaces. These activities, along with yet to be disclosed new dimensions, in turn, provide a wide open arena for creative and new advertising methods and mechanisms. Immersive virtual universes, among other things, are an avenue to expose potential consumers to a company's advertising. With the astounding and continual increase in the number of users of virtual worlds, companies are taking more interest in reaching out to virtual world residents through advertising.

However, current methods of triggering ads in VU's are not creative and inspiring for customers. This is because the current methods treat all potential customers the same, without any customization.

With the growing popularity of collaborative (e.g., Web 2.0) services (e.g., blogs, wikis, etc.), there is a realization that consumers are no longer satisfied with passive entertainment and/or advertising in which information is merely thrust upon them. Instead, it is perceived that VUs, simulation games, and/or television may merge to form a hybrid interactive entertainment experience and commerce medium. In accordance with this, implementations of the invention provide a three dimensional, immersive, and interactive experience for advertising a product and/or service. As such, embodiments of the invention provide consumers with a more interactive and enjoyable experience, while also providing sellers enhanced advertising techniques beyond traditional television and other passive media.

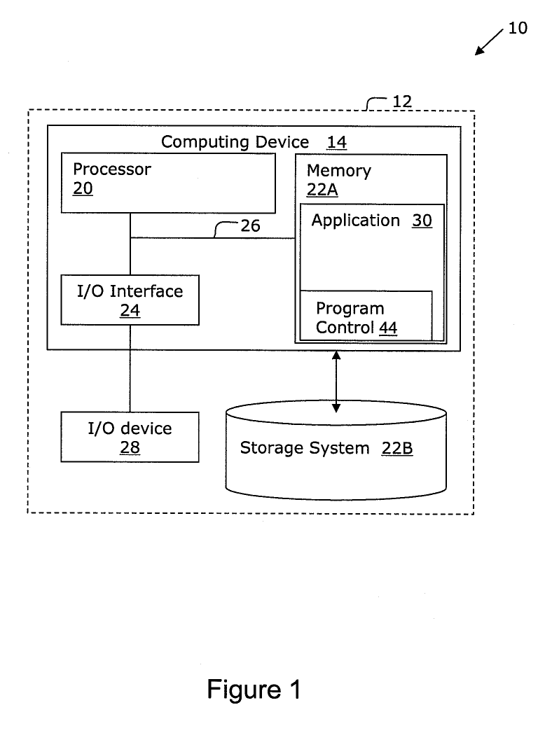

FIG. 1 shows an illustrative environment 10 for managing the processes in accordance with the invention. To this extent, the environment 10 includes a computer infrastructure 12 that can perform the processes described herein. In particular, the computer infrastructure 12 includes a computing device 14 that comprises an application 30 having a program control 44, which makes the computing device 14 operable to perform the processes described herein, such as, for example, provide customized advertising in a VU. The computing device 14 includes a processor 20, a memory 22A, an input/output (I/O) interface 24, and a bus 26. The memory 22A can include local memory employed during actual execution of program code, bulk storage, and cache memories which provide temporary storage of at least some program code (e.g., program control 44) in order to reduce the number of times code must be retrieved from bulk storage during execution. Further, the computing device 14 is in communication with an external I/O device/resource 28 and a storage system 22B. The I/O device 28 can comprise any device that enables an individual to interact with the computing device 14 or any device that enables the computing device 14 to communicate with one or more other computing devices using any type of communications link. The external I/O device/resource 28 may be keyboards, displays, pointing devices, etc.

The processor 20 executes computer program code (e.g., program control 44), which is stored in memory 22A and/or storage system 22B. While executing computer program code, the processor 20 can read and/or write data to/from memory 22A, storage system 22B, and/or I/O interface 24. The bus 26 provides a communications link between each of the components in the computing device 14.

The computing device 14 can comprise any general purpose computing article of manufacture capable of executing computer program code installed thereon (e.g., a personal computer, server, wireless notebook, smart phone, personal digital assistant, etc.). However, it is understood that the computing device 14 is only representative of various possible equivalent computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in embodiments, the computer infrastructure 12 comprises two or more computing devices (e.g., a server cluster) that communicate over any type of communications link, such as a network, a shared memory, or the like, to perform the processes described herein. Further, while performing the processes described herein, one or more computing devices in the computer infrastructure 12 can communicate with one or more other computing devices external to computer infrastructure 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, the invention provides a business method that performs the steps of the invention on a subscription, advertising, and/or fee basis. That is, a service provider, such as a Solution Integrator, could offer to perform the processes described herein, such as, for example, provide customized advertising in a VU. In this case, the service provider can create, maintain, deploy, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

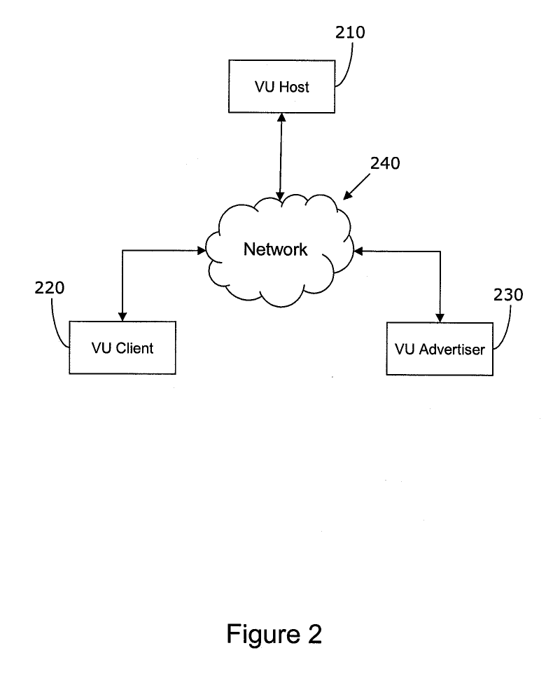

FIG. 2 shows an exemplary system according to aspects of the invention. In embodiments, a host 210 is operatively connected to at least one client 220 and at least one advertiser 230 via a network 240. The host 210 may comprise at least one computing device, such as that described with respect to FIG. 1, which operates the engine of a VU. For example, the host 210 may comprise a plurality of servers and/or databases that store data and provide the simulation engine(s) of a VU. Moreover, the network 240 may comprise any suitable communication network, such as, for example, the Internet.

In embodiments, the client 220 comprises a computing device, such as, for example, a general purpose computing device comprising at least a processor, memory, I/O interface, and I/O device. Such computing devices are known in the art, such that further explanation is not believed necessary. In embodiments, the client 220 operates a client program of the VU. The client 220 allows a human user to create a persona for use in the VU. For example, the persona may take the form of an avatar that is moveable throughout portions of the VU. Additionally, a profile of attributes of the user may be associated with the avatar. The profile may contain user-entered data regarding any suitable attributes of the user, such as, for example: age, gender, address, country of citizenship, occupation, hobbies, interests, etc. The profile data may be stored at the client 220 or at the host 210 (e.g., in a database, not shown). Moreover, there may be any suitable number of clients 220 interacting with the host 210. The host and client VU system described up to now is known in the art such that further explanation is not believed necessary.

Still referring to FIG. 2, in embodiments the advertiser 230 comprises a computing device, such as that described with respect to FIG. 1. Like the client 220, the advertiser 230 runs a client program of the VU. In embodiments, the advertiser 230 provides at least one immersive advertisement in the VU (referred to herein as a VU-ad). For example, the advertiser 230 may be used to create a script (e.g., program) that defines a VU-ad, and the program may be uploaded to the host 210. The VU-ad, whether run from the advertiser 230 or the host 210, may be controlled by a stored script (e.g., program), a human user, or a combination of both. The VU-ad may comprise any desired content that is perceptible by other users of the VU (via clients 220), which at least one user of the VU may watch, interact with, and/or become immersed in. When the VU-ad is at least partially controlled by a script, portions of the script may be stored at the advertiser 230 and/or at the host 210 (e.g., in a database, not shown).

In accordance with aspects of the invention, the VU-ad may take any suitable form. For example, the VU-ad may comprise, but is not limited to, any desired combination of: a pop-up graphic and/or text message that is displayed to the user, a graphic and/or text message displayed on a billboard (or other object) in the VU, a pop-up window that displays an animation and/or video to the user, an animation, video, or machinima displayed on a billboard (or other object) in the VU, a collection of ad objects and/or ad avatars in the VU that the user avatar is permitted to interact with, an ephemeral location to which the user avatar is teleported, etc. Any or all of these examples may include audible components that are also transmitted to the user. Moreover, any or all of these examples may further include the option of a human operator interacting with the user via, e.g., VOIP, text message, etc.

The VU-ad may be triggered (e.g., initiated) in any suitable manner. For example, triggers used in embodiments of the invention include, but are not limited to: a user moving (e.g., walking, flying, etc.) his or her avatar over a designated location in the VU, a user moving his or her avatar into contact with an object (e.g., billboard) in the VU, a user moving his or her avatar into contact with an object displaying a commercial (e.g., animation, video, machinima, etc.) in the VU, a user mouse-clicking on an object in the VU, a user communicating (e.g., via, VOIP, text message, etc.) a particular phrase in the VU, a user selecting an option from a menu, etc. In any of these examples, a user may knowingly trigger the VU-ad (e.g., by choosing a menu option), or may unknowingly trigger the VU-ad (e.g., by walking through a door). There is no requirement that the user want (e.g., intend to) trigger the VU-ad. Moreover, a VU-ad may have one or several such triggers. In embodiments, the triggers are defined in the script of the VU-ad.

In embodiments, a user profile is accessed by the VU-ad (e.g., by a program control, such as that described above with respect to FIG. 1) when the VU-ad is triggered, and aspects of the VU-ad are automatically altered based upon the data obtained from the profile. For example, the user profile (e.g., the user profile described above with respect to FIG. 2) may contain tolerance data regarding: the user's tolerance level (e.g., a measure of acceptable disruption) for advertisements, the user's preference for type of advertisement, and an indication of willingness to accept an incentive for being subject to an “disruptive” type of advertisement. In this manner, when a VU-ad is triggered by a user, the VU-ad is customized for the particular user based upon the tolerance data of the user.

According to aspects of the invention, the tolerance data may be defined by the user via the VU client program and stored at the client 220 or at the host 210 (e.g., in a database, not shown). For example, a user may be prompted to enter such data when creating an account with the VU. Additionally or alternatively, such tolerance data may be collected by the VU-ad provider and stored at the advertiser 230. For example, the VU-ad provider may solicit such tolerance data from users in the form of surveys (e.g., real word and/or online), and store such tolerance data in a database of multiple users.

In embodiments, the tolerance data includes a pre-defined measure of disruption that the user is willing to tolerate from advertisements. For example, the predefined measure of disruption may be rated as “low”, “medium”, or “high”. A ‘low’ tolerance level in the user profile may be defined to indicate that the user is willing to be subjected to minimally intrusive VU-ad, such as, for example, a picture, text message, or video displayed on an object (e.g., billboard) in the VU. A ‘medium’ tolerance level may be defined to indicate that the user is willing to be subjected to a relatively more intrusive advertisement, such as being approached and talked to by VU-ad avatars in the VU. A ‘high’ tolerance level may be defined to indicate that the user is willing to be subject to a highly intrusive advertisement, such as being teleported to another location in the VU where the VU-ad is staged. Although low, medium, and high are used in this example, the invention is not limited to these definitions of tolerance. For example, a numerical scale (e.g., 1 to 5), or any other suitable measure, could be used with the invention. The various tolerance levels and types of advertisements associated with each may be defined by the VU host (e.g., when tolerance data is stored at the client or the host), or by the VU-ad provider (e.g., when the tolerance data is collected by and stored at the advertiser).

In further embodiments, the tolerance data contained in the user profile includes an indication of the user's preferred type of VU-ad. As a non-limiting example, the tolerance data may indicate that the user prefers: pop-up messages, billboards, video displays, three-dimensional representations of scenes using ad avatars and ad objects, or teleportation to an ephemeral location, etc. The various types of advertisements may be defined by the VU host (e.g., when tolerance data is stored at the client or the host) or by the VU-ad provider (e.g., when the tolerance data is collected by and stored at the advertiser), and selected by the user (e.g., when creating a VU account).

In still further embodiments, the tolerance data contained in the user profile includes at least one indication of a level of interest in a particular subject. For example, a first indicator may include a user-defined value of a numerical scale (e.g., 1 to 10) of a level of interest in the subject of, for example, automobiles. A low level of interest in a subject indicates that the user is less willing to tolerate advertising related to the subject, while a higher level of interest indicates the user is more willing to tolerate advertising related to the subject. Any desirable subject may be utilized. Moreover, more than one subject may be represented in a user's profile. The various levels of interest associated with each subject may be defined by the VU host (e.g., when tolerance data is stored at the client or the host), or by the VU-ad provider (e.g., when the tolerance data is collected by and stored at the advertiser).

In yet further embodiments, the tolerance data contained in the user profile includes information regarding group behavior of the user's avatar. For example, the profile may include group behavior information indicating that the avatar is currently alone or traveling in a group. A user whose avatar is alone may be more willing to tolerate a VU-ad, while one that is in a group may be less likely to tolerate a VU-ad. Such information could be updated in the user profile by the VU-engine, for example, on a real-time basis. Such information can be used by the VU-ad in determining what type of VU-ad to display.

In even further embodiments, the tolerance data contained in the user profile includes an indication of the user's willingness to accept an increased (e.g., higher) level of disruption from an advertisement in exchange for an incentive. For example, a user's measure of disruption (described above) may be set at ‘low’; however, the user may indicate in the tolerance data a willingness to be subject to ‘medium’ or ‘high’ disruption VU-ads in exchange for compensation. The compensation may take any suitable form, such as, for example, virtual money placed in the user's VU account, object(s) placed in the user's VU inventory, coupons or promotional codes for real world purchases, etc. In a specific non-limiting example, a user may set up her user profile to have a baseline low disruption (e.g., tolerance) level, and be willing to accept medium disruption level VU-ads in exchange for a coupon and/or high disruption level VU-ads in exchange for virtual money. The incentives and disruption levels associated with each may be defined by the VU host (e.g., when tolerance data is stored at the client or the host), or by the VU-ad provider (e.g., when the tolerance data is collected by and stored at the advertiser).

Thus, according to aspects of the invention, when a user triggers a VU-ad, the user tolerance data is accessed and a customized VU-ad is presented based upon the user tolerance data. In this manner, a first user having first user tolerance data may be presented with a first variation of the VU-ad from a VU-ad provider, while a second user with different user tolerance data may be presented with a different variation of the VU-ad from the same VU-ad provider. For example, a first user who has a low tolerance (defined in the user profile) and is not willing to accept any incentives (also defined in the profile) may be presented with a billboard that displays a video commercial upon triggering the VU-ad. However, a second user that has a low tolerance but is willing to accept incentives for a high tolerance advertisement may be teleported to an ephemeral location where the VU-ad is presented upon activating the same trigger.

As another example, a first user that has a medium tolerance (defined in the user profile) and prefers pop-up messages (also defined in the profile) may be presented with a pop-up message upon activating a certain trigger. On the other hand, a second user that has a medium tolerance and prefers interacting with VU-ad avatars may be approached and talked to by VU-ad avatars upon activating the same trigger.

In further embodiments, when a user that does not have any associated tolerance data triggers a VU-ad, default settings are utilized when the VU-ad is triggered. The default settings may be pre-defined by and stored at the VU host and/or the VU advertiser. Alternatively, when a user that does not have any associated tolerance data triggers a VU-ad, the user may be prompted to enter appropriate profile settings (e.g., tolerance levels, type preference, willingness to change tolerance level based upon incentives, etc.).

As is apparent from the above-noted description, a VU-ad according to aspects of the invention may have multiple different versions (e.g., a low tolerance version, a medium tolerance version, a high tolerance version, etc.), any one of which may be presented to a particular user based upon the user's tolerance data. In embodiments, the different versions of the VU-ad are embodied in the program (e.g., script) that defines the VU-ad, and may be maintained, deployed, supported, or created by a service provider.

### Processes of the Invention

The steps of the flow diagrams described herein may be implemented in the environment of FIGS. 1 and/or 2. The flow diagrams may equally represent a high-level block diagram of the invention. The steps of the flow diagrams may be implemented and executed from a server, in a client-server relationship, by computing devices in an ad hoc network, or they may run on a user workstation with operative information conveyed to the user workstation. Additionally, the invention can take the form of an entirely hardware embodiment, an entirely software embodiment or an embodiment containing both hardware and software elements. In an embodiment, the software elements include firmware, resident software, microcode, etc.

Furthermore, the invention can take the form of a computer program product accessible from a computer-usable or computer-readable medium providing program code for use by or in connection with a computer or any instruction execution system. The software and/or computer program product can be implemented in the environments of FIGS. 1 and/or 2. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

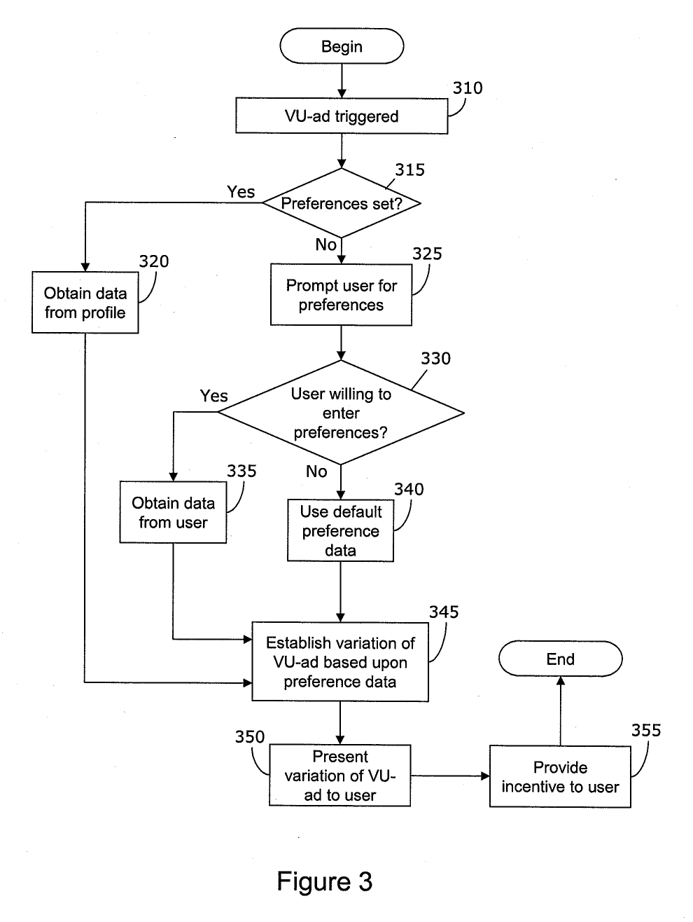

FIG. 3 shows a flow diagram depicting steps of an embodiment for implementing VU-ads in accordance with aspects of the invention. At step 310, the VU-ad is triggered. In embodiments, this is performed as described above. For example, a VU-ad may be triggered when a user moves (e.g., walks, flies, etc.) his or her avatar over a designated location in the VU, moves his or her avatar into contact with an object (e.g., billboard) in the VU, moves his or her avatar into contact with an object displaying a commercial (e.g., animation, video, machinima, etc.) in the VU, mouse-clicks on an object in the VU, states a particular phrase in the VU, selects an option from a menu, etc.

At step 315, the VU-ad determines (e.g., via a program control, such as that described above with respect to FIG. 1) if the user has preferences (e.g., tolerance data) defined in a user profile. In embodiments, the VU-ad attempts to find user tolerance data associated with the user from data storage locations such as the client computing device associated with the user, the VU-host (server and/or database), and/or the advertiser computing device. If user tolerance data is found, then the process proceeds to step 320, where the user tolerance data is obtained by the VU-ad.

If user tolerance data is not found at step 315, then the user is prompted to enter tolerance data at step 325. For example, the VU-ad may cause a message to be displayed to the user (via the client computing device) asking the user to enter tolerance information (e.g., acceptable disruption levels, type of ad preferences, acceptable incentives for accepting higher disruption ads, etc.). At step 330, the VU-ad determines whether the user is willing to provide tolerance information. For example, the VU-ad may receive an affirmative response or a denial from the user in response to the prompt at step 325. If the user is willing to provide tolerance information, then at step 335, the VU-ad obtains tolerance data form the user. In embodiments, this is accomplished by presenting the user with a pre-defined survey regarding preferences, and receiving the user's answers to the survey.

If the user declines to provide tolerance information in response to the prompt 325, then at step 340 the VU-ad associates default tolerance data with the user. For example, the default tolerance data may be pre-defined and stored at a data storage location that is accessible by the VU-ad.

At step 345, the VU-ad establishes the variation of the VU-ad to be presented to the user based upon the obtained user preferences (e.g., the user tolerance data, user data received from prompting, or default settings). For example, the VU-ad may employ a look-up table that associates variations of the VU-ad with specific combinations of user tolerance data.

At step 350, the variation of the VU-ad established in step 345 is presented to the user. In embodiments, this comprises presenting to the user (via the client computing device) any suitable combination of: a pop-up graphic and/or text message, a graphic and/or text message displayed on a billboard (or other object) in the VU, a pop-up window that displays an animation and/or video, an animation, video, or machinima displayed on a billboard (or other object) in the VU, a collection of ad objects and/or ad avatars in the VU that the user avatar is permitted to interact with, an ephemeral location to which the user avatar is teleported, human operator communication (e.g., via text message and/or VOIP), etc.

Optionally, at step 355, the VU-ad provides an incentive to the user. For example, the incentive may comprise, but is not limited to, any suitable combination of virtual money, coupons and/or promotional codes (e.g., usable in the VU and/or at real-world vendors, retailers, etc.), objects placed in the user's VU inventory, etc.

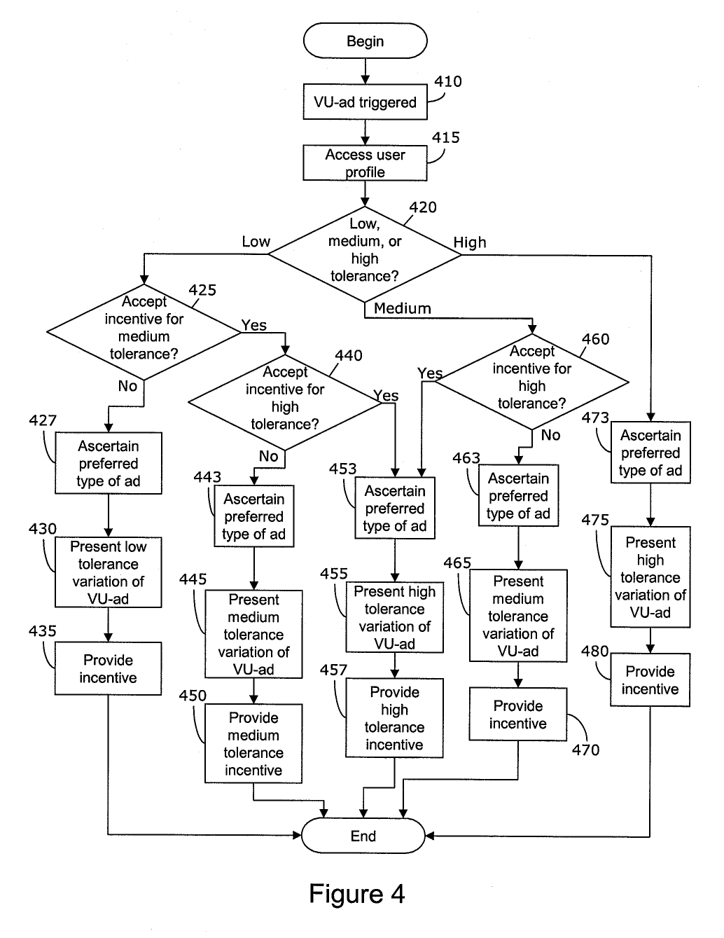

FIG. 4 shows a flow diagram depicting steps of an embodiment for implementing VU-ads. At step 410 the VU-ad is triggered. In embodiments, this is accomplished in a manner similar to step 310 described above. At step 415, the VU-ad accesses the user profile and obtains user tolerance data. In embodiments, this is accomplished in a manner similar to step 320 described above.

At step 420, the VU-ad determines from the user tolerance data whether the user has a low, medium, or high tolerance (or any other suitable measurement scale). If the user tolerance data indicates a low tolerance, then at step 425, the VU-ad determines from the user tolerance data if the user is willing to accept an incentive for a medium tolerance advertisement. If the user tolerance data indicates that the user is not willing to accept an incentive, then at step 427, the VU-ad determines from the user tolerance data the type of advertisement that this user prefers. For example, the user tolerance data may specify that the user prefers interactive advertisements. Then, at step 430, the VU-ad presents an appropriate variation of the advertisement to the user. For example, the VU-ad may establish the appropriate variation of the advertisement in a manner similar to step 345, and present the establish variation in a manner similar to step 350.

Optionally, at step 435, the VU-ad provides an incentive to the user. In embodiments, this may be performed in a manner similar to step 355, and the valuation of the incentive may be pre-defined based upon the variation of the advertisement that was presented. For example, a relatively less valuable incentive may be provided to a user who was presented with a low tolerance variation of the VU-ad may, while a relatively higher value incentive may be presented to a user who was presented with a high tolerance variation of the VU-ad.

If the user tolerance data indicates the user is willing to accept an incentive for a medium tolerance advertisement at step 425, then at step 440 the VU-ad determines whether the user is willing to accept an incentive for a high tolerance advertisement. If the user tolerance data indicates that the user is not willing to accept such an incentive, then at step 443, the VU-ad determines from the user tolerance data the type of advertisement that this user prefers (e.g., in a manner similar to step 427). Then, at step 445, the VU-ad presents an appropriate variation of the advertisement to the user (e.g., based upon tolerance level and preferred type, in a manner similar to step 430).

At step 450, the VU-ad provides an incentive to the user (e.g., in a manner similar to step 435). Because the user tolerance data indicated a willingness to accept an incentive for a medium tolerance advertisement, an appropriate incentive is provided to the user. For example, an appropriate incentive may be pre-defined in the user tolerance data and/or the VU-ad. Alternatively, the appropriate incentive may be determined in a manner similar to that described above with respect to step 435.

If the user tolerance data indicates the user is willing to accept an incentive for a high tolerance advertisement at step 440, then at step 453 the VU-ad determines from the user tolerance data the type of advertisement that this user prefers (e.g., in a manner similar to step 427). Then, at step 455, the VU-ad presents an appropriate variation of the advertisement to the user (e.g., based upon the tolerance level and preferred type, in a manner similar to step 430).

At step 457, the VU-ad provides an incentive to the user (e.g., in a manner similar to step 435). Because the user tolerance data indicated a willingness to accept an incentive for a high tolerance advertisement, an appropriate incentive is provided to the user. For example, an appropriate incentive may be pre-defined in the user tolerance data. Alternatively, the appropriate incentive may be determined in a manner similar to that described above with respect to step 435.

If the user tolerance data indicates a medium tolerance at step 420, then at step 460 the VU-ad determines whether the user is willing to accept an incentive for a high tolerance advertisement. If the user tolerance data indicates that the user is willing to accept such an incentive, then the process proceeds to steps 453, 455, and 457, already described.

If, at step 460, the user tolerance data indicates that the user is not willing to accept an incentive for a high tolerance advertisement, then at step 463 the VU-ad determines from the user tolerance data the type of advertisement that this user prefers (e.g., in a manner similar to step 427). Then, at step 465, the VU-ad presents an appropriate variation of the advertisement to the user (e.g., based upon tolerance level and preferred type, in a manner similar to step 430). Optionally, at step 470, the VU-ad provides an incentive to the user (e.g., in a manner similar to step 435).

If the user tolerance data indicates a high tolerance at step 420, then at step 473 the VU-ad determines from the user tolerance data the type of advertisement that this user prefers (e.g., in a manner similar to step 427). Then, at step 475, the VU-ad presents an appropriate variation of the advertisement to the user (e.g., based upon tolerance level and preferred type, in a manner similar to step 430). Optionally, at step 480, the VU-ad provides an incentive to the user (e.g., in a manner similar to step 435).

Moreover, at least one of the steps of FIGS. 3 and 4 may be performed on a computer infrastructure that is at least one of created, maintained, deployed, and supported by a service provider. In return for providing such a computer infrastructure, the service provider may receive payment from at least one of a VU user, VU advertising entity, and VU host. Furthermore, implementations of the invention are not limited to the examples described herein. Rather, any suitable values and measurements are also contemplated by the invention using the flow diagrams described herein.

While the invention has been described in terms of embodiments, those skilled in the art will recognize that the invention can be practiced with modifications and in the spirit and scope of the appended claims.

What is claimed:

1. A computer implemented method, comprising:
obtaining tolerance data about a user who triggers a virtual universe advertisement (VU-ad) in a virtual universe (VU); and
presenting a variation of the VU-ad to the user based upon the tolerance data.

2. The method of claim 1, wherein the tolerance data is stored in a profile associated with the user.

3. The method of claim 1, wherein the tolerance data is obtained from the user after the VU-ad is triggered.

4. The method of claim 1, wherein tolerance data includes at least one of:
a measure of the user's tolerance for advertising;
a preferred type of advertisement; and
an indication of willingness to modify the tolerance for advertising in exchange for an incentive.

5. The method of claim 1, further comprising providing an incentive to the user based upon the presenting the variation of the VU-ad to the user.

6. The method of claim 5, wherein the providing an incentive comprises at least one of:
transferring virtual money to an account of the user;
providing a promotional code to the user;
adding an object to an inventory of the user;
emailing a coupon to the user; and
mailing a coupon to the user.

7. The method of claim 1, wherein at least one of the obtaining and the presenting is provided by a service provider under a subscription and/or fee agreement and/or based on advertising content to one or more third parties.

8. The method of claim 1, wherein a service provider at least one of creates, maintains, deploys and supports a computer infrastructure that performs at least one of the obtaining and the presenting.

9. A computer implemented method for providing customized advertising in a virtual universe, comprising:
providing a program that defines a virtual universe advertisement (VU-ad);
presenting a first variation of the VU-ad to a first user based upon first tolerance data associated with the first user; and
presenting a second variation of the VU-ad to a second user based upon second tolerance data associated with the second user,
wherein the second variation is different from the first variation.

10. The method of claim 9, wherein the first and second tolerance data each includes at least one of:
a measure of tolerance for advertising;
a preferred type of advertisement;
an indication of willingness to modify the tolerance for advertising in exchange for an incentive;
a measure of a level of interest in a subject; and
information regarding group behavior.

11. The method of claim 9, further comprising providing an incentive to at least one of the first user and the second user.

12. The method of claim 9, comprising:
providing a first incentive to the first user; and
providing a second incentive, different from the first incentive, to the second user.

13. The method of claim 12, wherein:
the first incentive is based upon a first level of disruption acceptable to the first user,
the second incentive is based upon a second level of disruption acceptable to the second user, and
the first level of disruption is relatively higher than the second level of disruption.

14. A method for advertising in a virtual universe, comprising:
providing a computer infrastructure structured and arranged to:
access a profile of a user upon the user triggering a virtual universe advertisement (VU-ad) in a virtual universe (VU);
determine from the profile a tolerance level for advertising; and
present a variation of the VU-ad to the user based upon the tolerance level.

15. The method of claim 14, wherein the computer infrastructure is further arranged to determine a preferred type of advertisement from the profile.

16. The method of claim 15, wherein the variation of the VU-ad is based upon the tolerance level and the preferred type of advertisement.

17. The method of claim 14, wherein the computer infrastructure is further arranged to determine, from the profile, an indication of willingness to change the tolerance level in exchange for an incentive.

18. The method of claim 17, wherein the variation of the VU-ad is based upon the tolerance level and the indication of willingness to change the tolerance level.

19. The method of claim 14, wherein a service provider at least one of creates, maintains, deploys and supports the computer infrastructure.

20. A computer program product comprising a computer usable medium having a computer readable program embodied in the medium, wherein the computer readable program when executed on a computing device is operable to cause the computing device to:
present a variation of a virtual universe advertisement (VU-ad) to a user upon triggering of the VU-ad by the user,
wherein the variation is customized based upon a tolerance level of the user.

21. The computer program product of claim 20, wherein the variation is further based upon at least one of:
a preferred type of advertisement, and
an indication of willingness to change the tolerance level in exchange for an incentive.

22. The computer program product of claim 20, wherein the tolerance level is a default tolerance level assigned to the user.

23. A system, comprising:
computing hardware and software structured and arranged to:
obtain tolerance data about a user who triggers a virtual universe advertisement (VU-ad) in a virtual universe (VU); and
present a variation of the VU-ad to the user based upon the tolerance data,
wherein the tolerance data is stored in a profile associated with the user, and
the tolerance data is obtained from the user after the VU-ad is triggered.
